(19) United States
(12) Patent Application Publication
(10) Pub. No.: US 2016/0025561 A1
(43) Pub. Date: Jan. 28, 2016

(54) DISCOVERING AND CONSTRAINING IDLE PROCESSES

(71) Applicant: NEC Laboratories America, Inc., Princeton, NJ (US)

(72) Inventors: Yue Tian, Princeton, NJ (US); Ting Wang, West Windsor, NJ (US)

(21) Appl. No.: 14/807,286

(22) Filed: Jul. 23, 2015

Related U.S. Application Data
(60) Provisional application No. 62/028,868, filed on Jul. 25, 2014.

(51) Int. Cl. G01J 3/02; G01J 3/10; G01J 3/28

(52) U.S. Cl. CPC G01J 3/0205; G01J 3/28; G01J 3/10

(57) ABSTRACT

A spectroscopy system and method includes illuminating a target with a wideband light pulse that includes an entire testing wavelength spectrum. The light pulse is transformed with a dispersive medium to introduce a frequency-based time delay to the light pulse after the light pulse has interacted with a target. The dispersed light pulse is converted to a time-domain electrical signal with a photodiode. The time-domain electrical signal is converted into a spectral profile of the target.

### RELATED APPLICATION INFORMATION

This application claims priority to provisional application 62/028,868, filed Jul. 25, 2014, the contents thereof being incorporated herein by reference.

### BACKGROUND OF THE INVENTION

Optical spectroscopy is a technique for analysis of a material based on the material's absorption or emission of light. Every material has a characteristic spectral profile based on energy level transitions in its atoms and molecules, such that optical spectroscopy provides a deep knowledge of the material's makeup.

Due to the quantized nature of elementary particles, the electrons in an atom can only occupy discrete energy levels. When an incoming photon interacts with such an electron, the photon may be absorbed if it has the correct amount of energy to move the electron from one level to another. At some later point, the electron returns to a lower energy state and, in the process, emits a photon characteristic of that energy level transition in a random direction.

As a result, a beam of wideband light that hits the material will have certain wavelengths removed and re-radiated in other directions. The result is a profile of the spectral response of the material, with wavelengths passing through more easily if they interact less with the material. Of note, the energy level transitions are determined by the electrical properties of the atoms and molecules in the material. The resulting spectral profile is a fingerprint of the material.

In optical spectroscopy, the wavelength of tunable light sources is usually scanned across a target waveband to retrieve the spectral characteristics of a target. However, the scanning process takes time to complete. The larger the target waveband is, the longer the scan takes. To scan a spectrum that is rapidly varying, or to detect multiple sub-wavebands simultaneously, traditional spectroscopy technologies based on wavelength scanning have significant error due to the scanning lag across the whole waveband.

Wideband light sources, such as light emitting diodes and frequency combs, have been used to cover all of a target waveband without scanning wavelength-by-wavelength. After going through the sample, the different wavelength components in the output light are diffracted by a diffraction grating in different directions and are subsequently detected by multiple photodetectors or cameras simultaneously. But the requirement of multiple photodetectors or cameras increases the cost and size of the spectroscopy system. In addition, high-resolution diffraction gratings usually need precise temperature control, further complicating the system.

Other approaches have used pulsed lasers as wideband light sources and, at the detector side, us a reference light beam to beat with the optical pulses to retrieve a wideband signal profile. However, the generation of the reference light beam also increases the system complexity and an additional spectrum analyzer is needed to interpret the received spectral profile.

### BRIEF SUMMARY OF THE INVENTION

A spectroscopy system includes a wideband light source configured to emit a light pulse that includes an entire testing wavelength spectrum. A dispersive medium is configured to introduce a frequency-based time delay to the light pulse after the light pulse has interacted with a target. A photodiode is configured to convert the dispersed light pulse to a time-domain electrical signal. An analysis module is configured to convert the time-domain electrical signal into a spectral profile of the target.

A spectroscopy method includes illuminating a target with a wideband light pulse that includes an entire testing wavelength spectrum. The light pulse is transformed with a dispersive medium to introduce a frequency-based time delay to the light pulse after the light pulse has interacted with a target. The dispersed light pulse is converted to a time-domain electrical signal with a photodiode. The time-domain electrical signal is converted into a spectral profile of the target.

### BRIEF DESCRIPTION OF THE DRAWINGS

FIG. 1 is a diagram of a spectroscopy system in accordance with the present principles.

FIG. 2 is a block/flow diagram of a method of spectroscopy in accordance with the present principles.

FIG. 3 is a block diagram of a spectroscopy system in accordance with the present principles.

### DETAILED DESCRIPTION

Embodiments of the present invention provide single-shot spectroscopy based on a pulsed light source and a highly dispersive medium. The pulsed light source has a wide spectral bandwidth covering the entire target waveband. The output pulse after interaction with the sample passes through a highly dispersive medium, in which wavelength components experience different time delays. As a result, the different wavelengths separate into the time domain. At the end, a high-speed photodetector receives the dispersed light signal. The time-varying signal represents the signal across the whole target waveband.

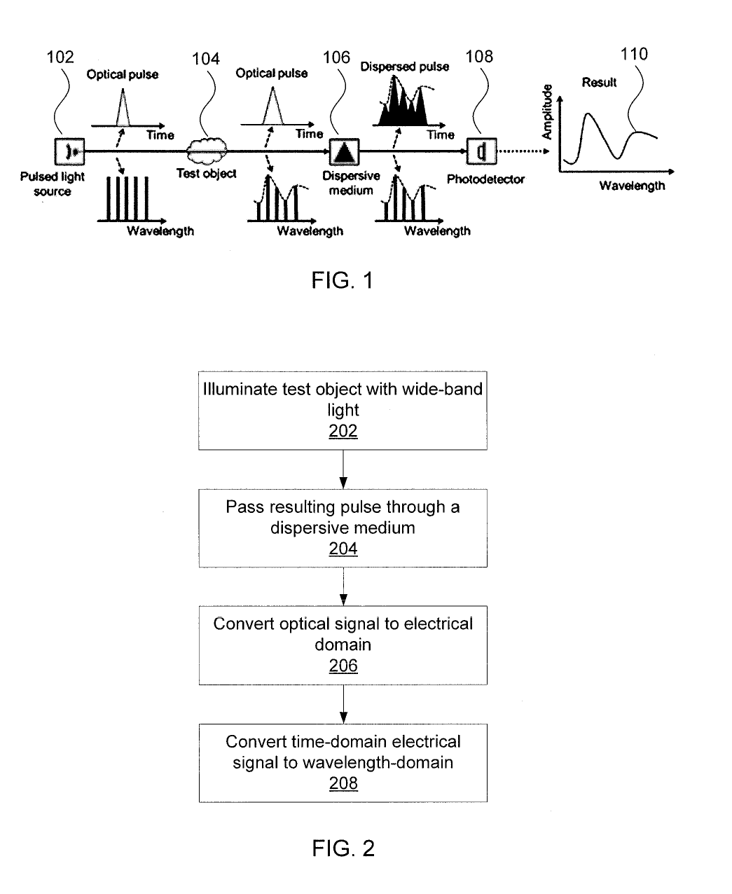

Referring now to FIG. 1, a single-shot spectroscopy system is shown. A light source 102 uses any appropriate form of light generating device to produce a band of light that covers a target waveband. Exemplary light sources include light emanating diodes (LEDs), laser pulses, optical frequency combs, etc. In one specific embodiment, the light source 102 is a pulsed laser that emits a short duration optical pulse. Due to the short duration, the optical pulse has a relatively wide band in the frequency/wavelength domain.

The optical pulse output by the light source 102 interacts with a test object 104. Interaction with the test object produces a modified pulse that results from the object's optical properties. In particular, materials in the test object 104 reflect or absorb certain frequencies of the original light pulse, producing a characteristic spectrum response.

The modified pulse passes through a dispersive medium or structure 106. The dispersive medium may be any medium that provides an appropriate frequency-based delay to a multi-frequency input signal. As shown, the dispersive medium 106 converts the wavelength-domain signal into a time-domain signal, as different frequencies are slowed by different amounts. The dispersive medium or structure 106 thereby provides an amplitude profile that is the same as the test object 104's spectral profile. Exemplary dispersive media include crystals, optical lenses, and optical waveguides. Exemplary dispersive structures may include optical delay lines with optical filters and gratings. A high-speed photodetector 108 receives the time-domain signal and converts from optical domain into the electrical domain. The resulting waveform 110 provides an instantaneous measurement of the entire waveband that makes up the testing wavelength spectrum.

Notably, there is a tradeoff between time sensitivity of the photodetector 108 and the dispersion value of the dispersive medium 106. The time response of the photodetector needs to be fast enough to distinguish the time-domain profile change of the dispersed optical signal so that it can retrieve the spectral profile at a certain resolution. Using a slower photodetector 108 means that a more dispersive medium 106 needs to be used to reach the same resolution. The resolution of the entire system is therefore determined by the dispersion value of the dispersion medium 106 and the speed of the photodetector 108.

Referring now to FIG. 2, a method for single-shot spectroscopy is shown. Block 202 illuminates the test object 104 with the wide-band light source 102. Block 204 passes the resulting light pulse through a dispersive medium 106 to transform the light pulse, providing wavelength-dependent delays to the output light pulse. Block 206 uses the photodetector 108 to convert the optical signal to a time-domain electrical signal and block 208 converts the time-domain electrical signal to a representation of the spectral profile 110 of the test object 104 in the wavelength domain. The final spectral profile 110 includes an amplitude measurement for each wavelength in the testing

It should be understood that embodiments described herein may be entirely hardware, entirely software or including both hardware and software elements. In a preferred embodiment, the present invention is implemented in hardware and software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

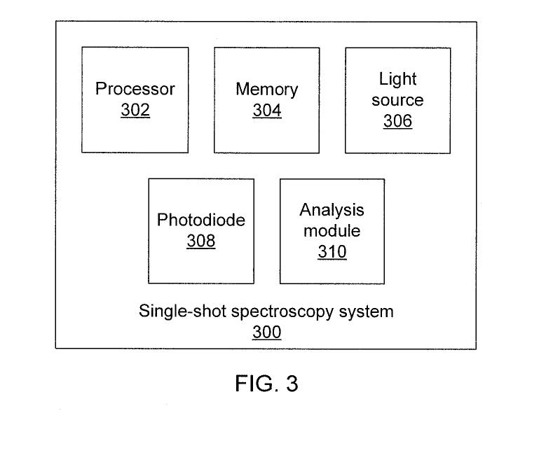

Referring now to FIG. 3, a single-shot spectroscopy system 300 is shown. The system 300 includes a processor 302 and memory 304. While the processor 302 and memory 304 are shown as being discrete hardware components, it should be understood that the present embodiments may include hardware-only embodiments, such as application-specific integrated chips, or may include software that is executed using such a processor. As such, the modules listed herein may be discrete, standalone components, may be software executed on the hardware processor 302 and memory 304, or may be components that interface with the processor 302 and memory 304 for one or more functions.

A light source 306 provides the wideband light pulse described above, while a photodiode 308 captures the time-domain optical signal after it has struck the target 104 and passed through the dispersive medium 108. The photodiode 308 converts the optical signal into the electrical domain and stores the resulting waveform in memory 304. Analysis module 310 uses the processor 302 to analyze the stored waveform, converting the time-domain waveform into a wavelength domain waveform that represents the spectral profile of the target 104. It should be recognized that the shape of the time domain waveform corresponds directly to the shape of the spectral profile, as the dispersive medium 106 provides a linear transformation based on frequency.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A spectroscopy system, comprising:
a wideband light source configured to emit a light pulse that includes an entire testing wavelength spectrum;
a dispersive medium configured to introduce a frequency-based time delay to the light pulse after the light pulse has interacted with a target;
a photodiode configured to convert the dispersed light pulse to a time-domain electrical signal; and
an analysis module configured to convert the time-domain electrical signal into a spectral profile of the target.

2. The spectroscopy system of claim 1, wherein the spectral profile comprises an amplitude response for each wavelength in the testing wavelength spectrum.

3. The spectroscopy system of claim 1, wherein the wideband light source is configured to generate a short-duration light pulse that has wideband wavelength coverage.

4. The spectroscopy system of claim 3, wherein the wideband light source is a laser.

5. The spectroscopy system of claim 1, wherein the dispersive medium comprises a dispersive structure including one of a grating and an optical filter with optical delay lines.

6. The spectroscopy system of claim 1, wherein the dispersive medium comprises one of a crystal, an optical lens, and an optical waveguide.

7. A spectroscopy method, comprising:
illuminating a target with a wideband light pulse that includes an entire testing wavelength spectrum;
transforming the light pulse with a dispersive medium to introduce a frequency-based time delay to the light pulse after the light pulse has interacted with a target;
converting the dispersed light pulse to a time-domain electrical signal with a photodiode; and
converting the time-domain electrical signal into a spectral profile of the target.

8. The spectroscopy method of claim 7, wherein the spectral profile comprises an amplitude response for each wavelength in the testing wavelength spectrum.

9. The spectroscopy method of claim 7, wherein illuminating the target comprises generating a short-duration light pulse that has wideband wavelength coverage.

10. The spectroscopy method of claim 9, wherein generating the short-duration light pulse comprises illuminating the target with a laser.

11. The spectroscopy method of claim 7, wherein the dispersive medium comprises a dispersive structure including one of a grating and an optical filter with optical delay lines.

12. The spectroscopy method of claim 7, wherein the dispersive medium comprises one of a crystal, an optical lens, and an optical waveguide.
